(19) United States
(12) Patent Application Publication
(10) Pub. No.: US 2007/0211416 A1
(43) Pub. Date: Sep. 13, 2007

(54) LIQUID CRYSTAL DISPLAY DEVICE

(75) Inventors: YUE-HAI ZHANG, Shenzhen (CN); LIN-YUN HONG, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/563,150

(22) Filed: Nov. 25, 2006

(30) Foreign Application Priority Data
Mar. 10, 2006 (CN) 200620056233.4

(51) Int. Cl. G06F 1/16

(52) U.S. Cl. 361/681

(57) ABSTRACT

A liquid crystal display (LCD) device includes a cover, an LCD panel, and a bezel together with the cover for sandwiching the LCD panel. The cover includes a board, a side flange extending from a side of the board, and two end flanges extending from opposite ends of the board. An orientation portion extends from a distal end of the side flange toward an opposite side of the board. A first locating portion extends from an inner surface of one end flange of the end flanges. A first hook extending from a corresponding side of the bezel has a restriction part extending up therefrom, for being located under the orientation portion of the cover. A second locating portion extending from a corresponding end of the bezel has a locating part at a distal end thereof, for being located under the first locating portion of the cover.

### BACKGROUND OF THE INVENTION

1. Field of the Invention

The present invention relates to Liquid Crystal Display (LCD) devices, and particularly to an LCD device having an LCD panel readily installed or removed.

2. Description of Related Art

A typical folded electronic device, such as a notebook computer, includes a main system, and a display device pivotably mounted to the main system. The display device includes a bracket, and an LCD panel. A plurality of screw holes is defined in opposite sides of the LCD panel. A plurality of through-holes is defined in opposite sides of the bracket. Screws are inserted through the through-holes to engage in the corresponding screw holes to secure the LCD panel to the bracket. However, this way of securing the LCD panel uses many screws, which is unduly painstaking and time-consuming.

What is desired, therefore, is an LCD device which readily allows installation or removal of an LCD panel.

### SUMMARY OF THE INVENTION

An exemplary liquid crystal display (LCD) device includes a cover and a bezel for sandwiching an LCD panel. The cover includes a board, a side flange extending from a side of the board, and two end flanges extending from opposite ends of the board. An orientation portion extends from a distal end of the side flange toward an opposite side of the board. A first locating portion extends from an inner surface of one end flange of the end flanges. A first hook extending from a corresponding side of the bezel has a restricting part extending up therefrom, for being located under the orientation portion of the cover. A second locating portion extending from a corresponding end of the bezel has a locating part at a distal end thereof, for being located under the first locating portion of the cover.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a liquid crystal display device in accordance with a preferred embodiment of the present invention, the liquid crystal display device includes a bezel, a cover, and an LCD panel;

FIG. 2 is an enlarged view of a circled portion II of FIG. 1;

FIG. 3 is an enlarged view of a circled portion III of FIG. 1;

FIG. 4 is an inverted isometric view of the bezel of FIG. 1;

FIG. 5 is an enlarged view of a circled portion V of FIG. 4;

FIG. 6 is an assembled view of the bezel and the LCD panel of FIG. 1;

FIG. 7 is an assembled view of FIG. 1, but partially cutaway; and

FIG. 8 is an enlarged view of a circled portion VIII of FIG. 7.

### DETAILED DESCRIPTION OF THE INVENTION

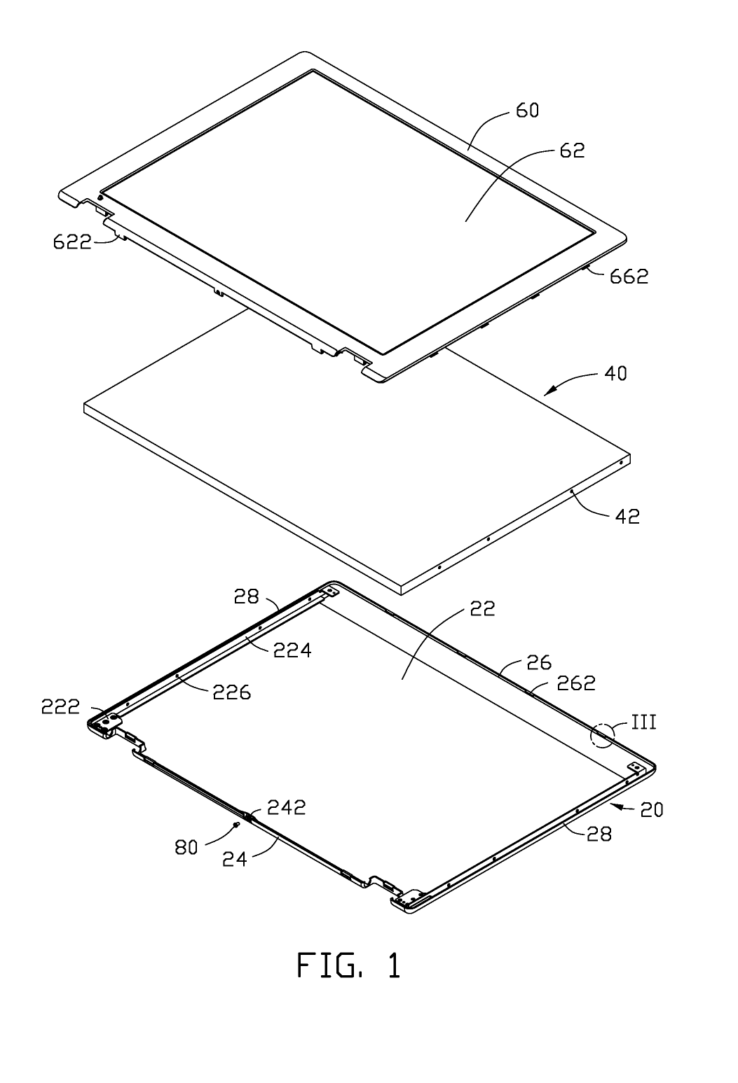

Referring to FIG. 1, a liquid crystal display (LCD) device in accordance with a preferred embodiment of the present invention includes a cover 20, an LCD panel 40, and a bezel 60. The LCD panel 40 defines a plurality of locking holes 42 in opposite sides thereof.

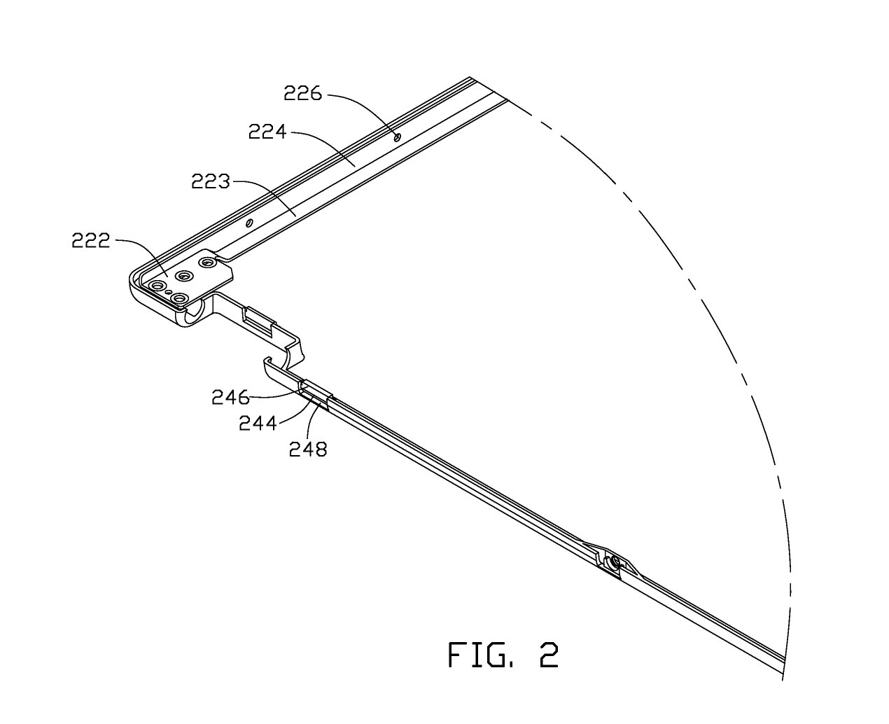

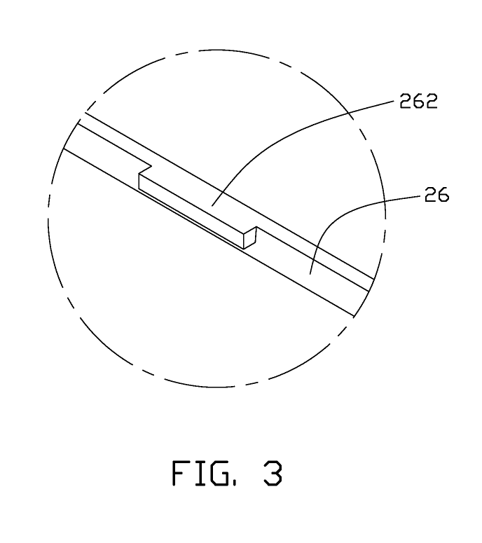

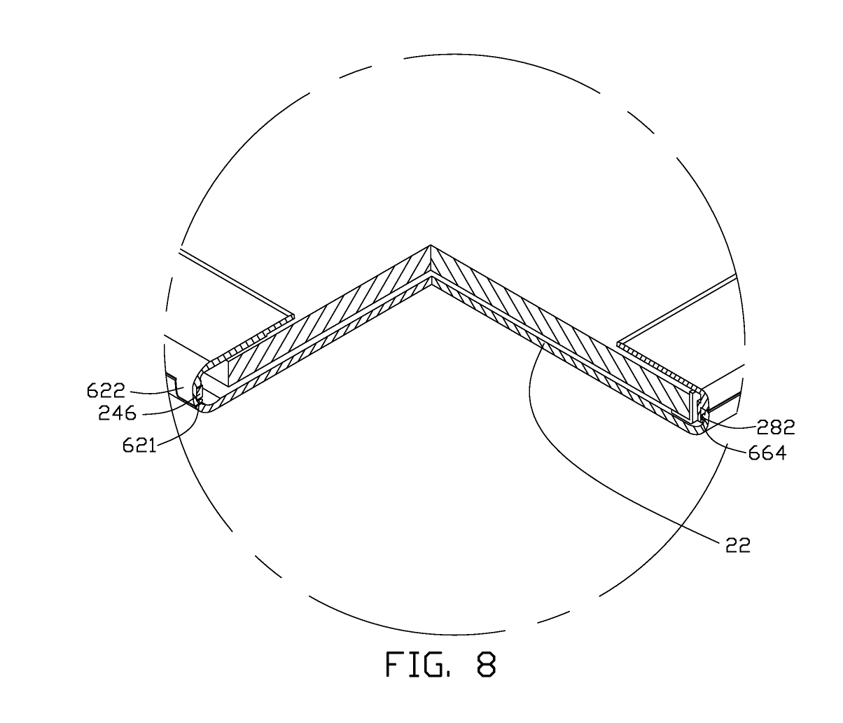

Referring also to FIGS. 2 and 3, the cover 20 includes a board 22, a side flange 24 extending from a side of the board 22, a side flange 26 extending from an opposite side of the board 22, and two end flanges 28 extending from opposite ends of the board 22. A plurality of first cutouts 248 is defined in the side flange 24. A blocking portion 246 is formed at each first cutout 248. A slot 244 is formed between each blocking portion 246 and a bottom of a corresponding first cutout 248. A depressed portion (not labeled) is formed at a middle of the side flange 24. A fixing hole 242 is defined in the depressed portion. A plurality of orientation portions 262 extends from a distal end of the side flange 26 toward the side flange 24. A plurality of first locating portions 282 (see FIG. 8) extends from each end flange 28 toward an opposite end flange 28. A mounting member 222 is mounted to each end of the board 22. Each mounting member includes a mounting portion 223 secured to a corresponding end of the board 22, and a fixing portion 224 perpendicularly extending from the mounting portion 223 and facing a corresponding end flange 28. A plurality of through-holes 226 is defined in the fixing portion 224 of each mounting member 222.

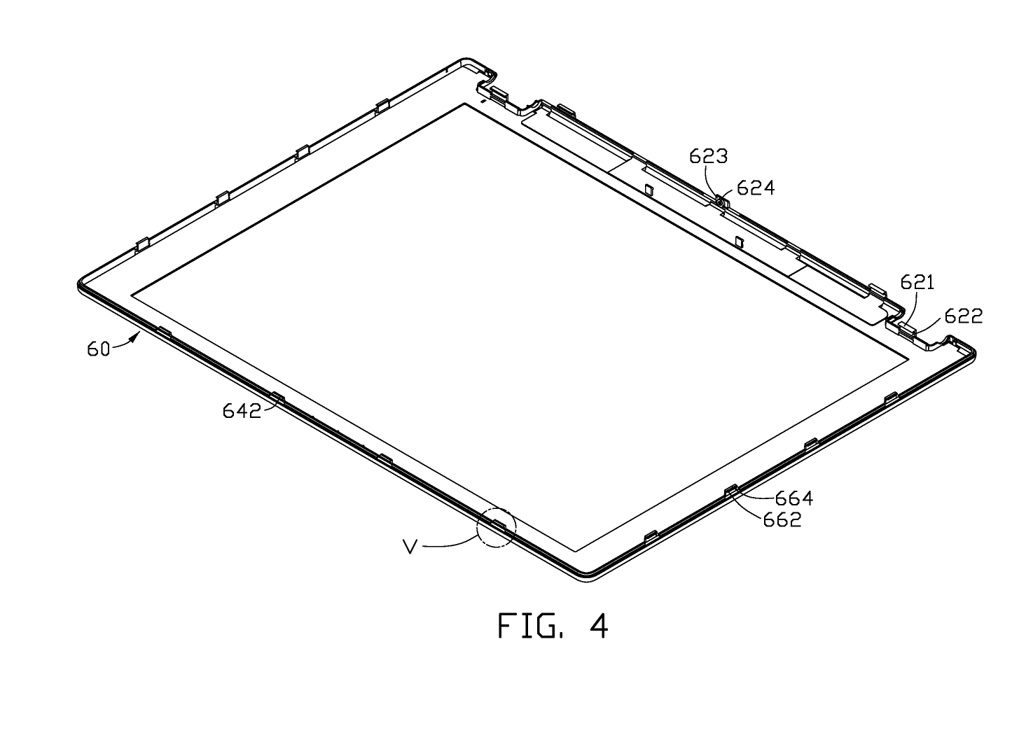

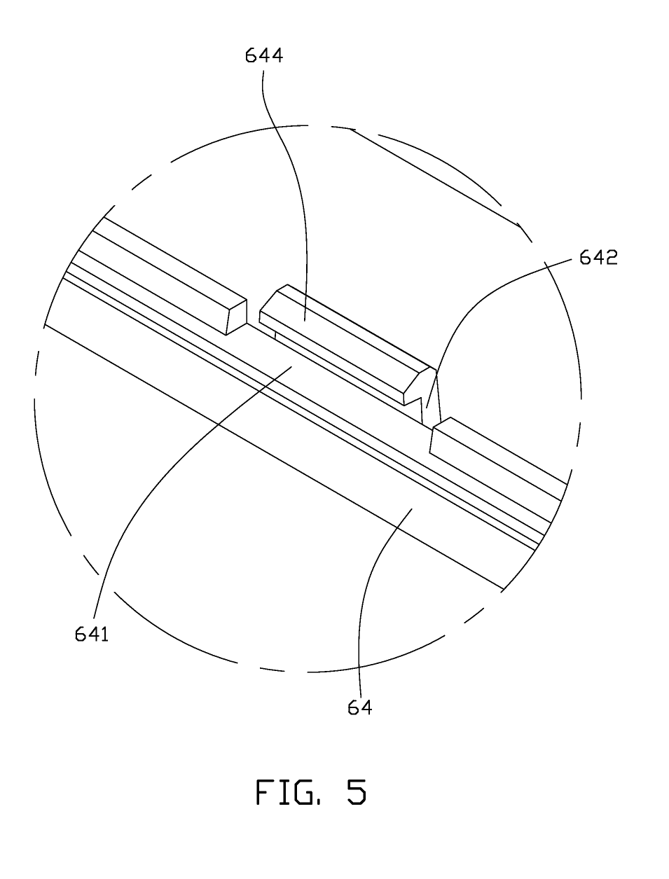

Referring to FIGS. 4 and 5, the bezel 60 defines an opening 62 therein, for the LCD panel 40 being exposed therethrough. A plurality of L-shaped first hooks 622 extends from a side of the bezel 60, corresponding to the blocking portion 246 of the cover 20. Each first hook 622 includes a limiting part 621 extending toward an opposite side of the bezel 60 from a distal end thereof. A fastening tab 623 extends from the bezel 60. A fastening hole 624 is defined in the fastening tab 623. A plurality of L-shaped second locating portions 662 extends from opposite ends of the bezel 60. Each second locating portion 662 includes a locating part 664 at a distal end thereof. The second locating portions 662 at one end of the bezel 60 are opposite to the corresponding second locating portions 662 at the other end of the bezel 60. A plurality of second cutouts 641 is defined in the side of the bezel 60 opposite to the first hooks 622. An L-shaped second hook 642 extends from the bezel 60 at each second cutout 641. Each second hook 642 includes a restricting part 644 extending out from a distal end thereof.

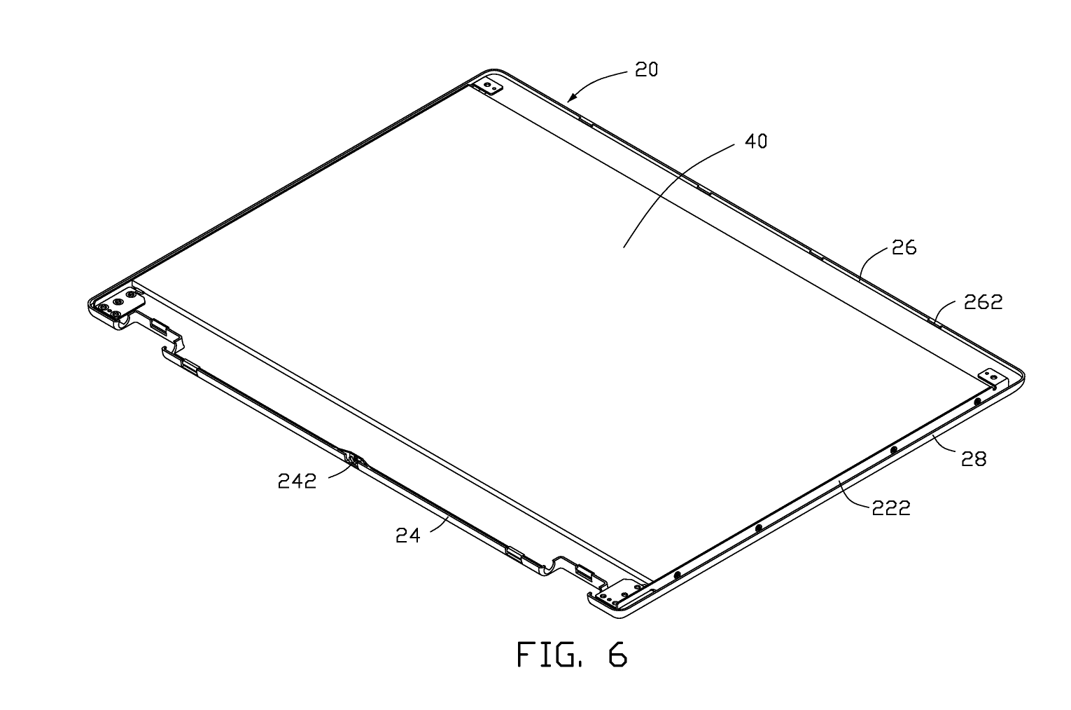

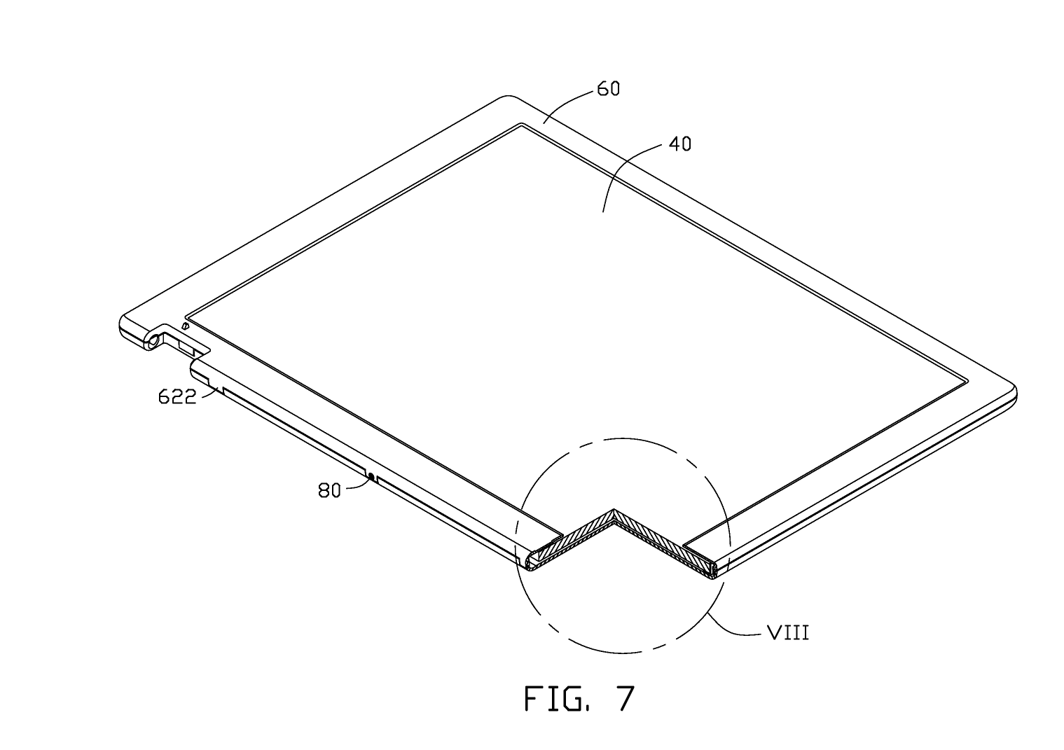

Referring to FIGS. 1-8, in assembly, the LCD panel 40 is placed onto the board 22 of the cover 20. Screws (not shown) are inserted through the corresponding through-holes 226 of the mounting members 222 to engage in the corresponding locking holes 42 of the LCD panel 40. The bezel 60 is attached to the cover 20, with the side having the first hooks 622 thereof protruding from a corresponding side of the cover 20. The first hooks 622 of the bezel 60 face the corresponding slots 244 of the cover 20. The second hooks 642 of the bezel 60 face the corresponding orientation portions 262 of the cover 20. The second locating portions 662 of the bezel 60 are offset from the corresponding first locating portions 282 of the cover 20. The bezel 60 is pushed until the side having the first hooks 622 thereof, aligns with the corresponding side of the cover 20. The limiting parts 621 of the first hooks 622 of the bezel 60 are inserted into the corresponding slots 244 and located under the corresponding blocking portions 246 of the cover 20. The restriction parts 644 of the second hooks 642 of the bezel 60 move under and engage with the corresponding orientation portions 262 of the cover 20. The locating parts 664 of the second locating portions 662 of the bezel 60 are located under the corresponding first locating portions 282 of the cover 20. The fastening tab 623 is received in the depressed portion of the cover 20, with the fastening hole 624 thereof aligning with the fixing hole 242 of the cover 20. A screw 80 is inserted through the fastening hole 624 of the bezel 60 to engage in the fixing hole 24 of the cover 20. Thus, the LCD panel 40 is mounted between the cover 20 and the bezel 60.

In disassembly, the screw 80 is released from the fixing hole 242 of the cover 20 and removed from the fastening hole 624 of the bezel 60. The bezel 60 is pushed until the side having the first hooks 622 thereof protruding from the corresponding side of the cover 20. The first hooks 622 of the bezel 60 are disengaged from the corresponding blocking portions 246 of the cover 20. The orientating portions 262 of the cover 20 are removed from the corresponding second cutouts 641 to disengage from the corresponding second hooks 642 of the bezel 60. The second locating portions 662 of the bezel 60 are offset from the corresponding first locating portions 282 of the cover 20. The bezel 60 is then removed from the cover 20. The LCD panel 40 is then removed from the bezel 10 easily.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A liquid crystal display (LCD) device, comprising:
a cover comprising a board, a first side flange extending from a side of the board, and two end flanges extending from opposite ends of the board, an orientation portion extending from a distal end of the first side flange toward an opposite side of the board, a first locating portion extending from an inner surface of one end flange of the end flanges;
an LCD panel; and
a bezel together with the cover for sandwiching the LCD panel, a first hook extending from a side of the bezel, the first hook having a restriction part extending out therefrom, for being located under the orientation portion of the cover, a second locating portion extending from a corresponding end of the bezel, the second locating portion having a locating part at a distal end thereof, for being located under the first locating portion of the cover.

2. The LCD device as claimed in claim 1, wherein the cover further comprises a second side flange extending from the opposite side of the board of the cover, a depressed portion is formed at the second side flange, the depressed portion defines a fixing hole therein, a fastening tab extends from a corresponding side of the bezel and is located in the depressed portion, the fastening tab defines a fastening hole therein, a fastener is inserted through the fastening hole of the bezel to engage in the fixing hole of the cover.

3. The LCD device as claimed in claim 1, wherein the cover further comprises a second side flange extending from the opposite side of the board of the cover, a first cutout is defined in the second side flange, a blocking portion is formed at the first cutout, with a slot being formed thereunder, a second hook extends from a corresponding side of the bezel, the second hook has a limiting part extends toward an opposite side of the bezel, for engaging in the slot of the cover.

4. The LCD device as claimed in claim 1, wherein a mounting member is mounted to the board and at each of the ends of the board, for mounting the LCD thereto.

5. The LCD device as claimed in claim 4, wherein each of the mounting members includes a mounting portion mounted to the board of the cover, and a fixing portion perpendicularly extending from the mounting portion, opposite ends of the LCD panel are mounted to the fixing portions of the corresponding mounting members.

6. The LCD device as claimed in claim 5, wherein the fixing portion of each of the mounting members defines a plurality of through-holes therein, each of the ends of the LCD panel defines a plurality of locking holes therein, fasteners are inserted through the corresponding through-holes of the mounting members to engage in the corresponding locking holes of the LCD panel.

7. A liquid crystal display (LCD) device, comprising:
a cover comprising a board, a first side flange extending from a side of the board, and two end flanges extending from opposite ends of the board, the first side flange defining a slot therein, a first locating portion extending from an inner surface of one end flange of the end flanges;
an LCD panel; and
a bezel together with the cover for sandwiching the LCD panel, a hook extending from a corresponding side of the bezel, the hook having a limiting part extending toward an opposite side of the bezel, for engaging in the slot of the cover, a second locating portion extending from a corresponding end of the bezel, the second locating portion having a locating part at a distal end thereof, for being located under the first locating portion of the cover.

8. The LCD device as claimed in claim 7, wherein a depressed portion is formed at the first side flange of the cover, the depressed portion defines a fixing hole therein, a fastening tab extends from the corresponding side of the bezel and is received in the depressed portion, the fastening tab defines a fastening hole therein, a fastener is inserted through the fastening hole of the bezel to engage in the fixing hole of the cover.

9. The LCD device as claimed in claim 7, wherein a first cutout is defined in the first side flange of the cover, a blocking portion is formed at the first cutout, the slot is formed under the blocking portion.

10. The LCD device as claimed in claim 7, wherein two mounting members are mounted to opposite ends of the board respectively, for mounting the LCD thereto.

11. The LCD device as claimed in claim 10, wherein each of the mounting members includes a mounting portion mounted to the board of the cover, and a fixing portion perpendicularly extending from the mounting portion, opposite ends of the LCD panel are mounted to the fixing portions of the corresponding mounting members.

12. The LCD device as claimed in claim 11, wherein the fixing portion of each of the mounting members defines a plurality of through-holes therein, each of the ends of the LCD panel defines a plurality of locking holes therein, fasteners are inserted through the corresponding through-holes of the mounting members to engage in the corresponding locking holes of the LCD panel.

13. A liquid crystal display (LCD) device comprising:
a cover comprising a board, a pair of side flanges extending from two sides of the board and a pair of end flanges extending from two ends of the board, each end flange connecting one end of a side flange with a corresponding end of the other side flange; the end flanges providing first locating portions;
a bezel slidably attached to the cover in a front-to-back direction, the bezel forming second locating portions configured for slidably engaging with the first locating portions to locate the bezel with respect to the cover in up-to-down and left-to-right directions;
a limiting structure being formed between the side flanges and the bezel configured for limiting movement of the bezel relative to the cover in the front-to-back direction; and
an LCD panel sandwiched between the cover and the bezel.

14. The LCD device as claimed in claim 13, wherein the limiting structure comprises a plurality of slots defined at one of the side flanges and a plurality of L-shaped hooks formed at the bezel and configured for engaging in the slots respectively.

15. The LCD device as claimed in claim 13, wherein the limiting structure comprises a plurality of latches extending inwardly from one of the side flanges and a plurality of L-shaped hooks formed at the bezel configured for engaging with the latches respectively.

16. The LCD device as claimed in claim 13, wherein a depressed portion sinking inwardly is formed at one of the side flanges, and a locking portion is formed at the bezel and configured for locking with the depressed portion to prevent the bezel withdrawing from the cover in the front-to-back direction.

17. The LCD device as claimed in claim 13, wherein a pair of mounting members is mounted at the cover and secured to opposite sides of the LCD panel respectively.

18. The LCD device as claimed in claim 13, wherein the second locating portions are L-shaped and the first locating portions are tabs extending perpendicularly from the end flanges configured for slidably engaging with the L-shaped locating portions respectively.
